(19) United States
(12) Patent Application Publication
(10) Pub. No.: US 2026/0142387 A1
(43) Pub. Date: May 21, 2026

(54) HIGH VOLTAGE CONNECTOR FOR AN ALUMINUM CABLE WITH A COPPER TERMINAL

(71) Applicant: Aptiv Technologies AG, Schaffhausen (CH)

(72) Inventors: Vamsi Venkata DINAVAHI, Lautertal (DE); Maxime PORTE, Nuremberg (DE)

(21) Appl. No.: 19/380,188

(22) Filed: Nov. 5, 2025

(30) Foreign Application Priority Data
Nov. 19, 2024 (EP) 24213996.2

(51) Int. Cl. H01R 4/62; H01R 4/02; H01R 4/16; H01R 4/18; H01R 4/60; H01R 11/01; H01R 43/02; H01R 43/04

(52) U.S. Cl. CPC H01R 4/62; H01R 4/023; H01R 4/16; H01R 4/183; H01R 4/60; H01R 11/01; H01R 43/02; H01R 43/04

(57) ABSTRACT

A connector includes an aluminum cable, a copper terminal, and an aluminum junction part having a first end configured to join to the aluminum cable and a second end configured to join to the copper terminal. By providing the junction part in aluminum, the connector establishes a metallurgically compatible interface and enables efficient electrical conduction between the aluminum cable and the copper terminal.

### CROSS-REFERENCE TO RELATED APPLICATION

This application claims the benefit of and priority to European Application No. 24213996.2 filed with the European Patent Office on Nov. 19, 2024, the contents of which are incorporated by reference herein.

### TECHNICAL FIELD

The present disclosure relates to a connector comprising an aluminum cable and a copper terminal.

### BACKGROUND

It is known to make electrical connectors out of copper. Transport cables are also made of copper. Copper is a very good electrical conductor. Since both the connector and the cable are of the same matter, joining a connector to a cable, e.g. by welding is easy.

Now, there is a great need to replace the cable with aluminum. Aluminum is also a very good electrical conductor but is lighter and cheaper. For compatibility reasons, with existing copper connectors and their copper terminals, the terminal must remain in copper. Accordingly, there is a need for a connector joining an aluminum cable with a copper terminal.

### SUMMARY

This disclosure is directed to a connector, comprising an aluminum cable, a copper terminal, and a junction part, wherein the junction part is made of aluminum and comprises a first end able to be joined to the aluminum cable and a second end able to be joined to the copper terminal. Some specific features or embodiments, usable alone or in combination, are:
the second end comprises a first face perpendicular to a connector's axis, and the copper terminal comprises a corresponding second face perpendicular to the connector's axis, facing the first face, and one of the faces among the first face of the second end and the second face of the copper terminal comprises an outer chamfer and the other face comprises a corresponding inner chamfer, shaped to cover and receive the outer chamfer, and both chamfers are joined by cold forging,
the cold forging is applied radially on both chamfers so as to radially interpenetrate the outside chamfer into the inside chamfer, so as to inhibit any axial and radial relative movement of the chamfers,
both chamfers are angled, with respect to the connector's axis, between 30° and 60°, preferentially 45°,
the first face of the second end and the second face of the copper terminal are wholly separated by a first coating of silver, disposed between the first face and the second face, and a second coating of nickel, disposed between the first coating and the second face,
the first end comprises an inner cylinder, along the connector's axis, set up to tightly receive the aluminum cable, and the aluminum cable, inserted in the inner cylinder, and the inner cylinder of the first end, are joined by EMPT welding,
the connector further comprises a centrepin, the center pin being integral to the copper terminal,
the connector further comprises a centrepin, both faces comprise an axial hole, along the connector's axis, set up to tightly receive the centrepin, and the center pin and the axial hole, once engaged one another, are joined by longitudinal crimping, and
the distal end of the centrepin is made of an insulating material.

The invention is further directed to a method of manufacturing such a connector, comprising the following steps:
inserting the outer chamfer into the inner chamfer,
joining the second end of the junction part with the copper terminal by cold forging, so as to interpenetrate both chamfers, and
joining the first end with the aluminum cable by EMPT welding, the last two steps being applied either in this order or simultaneously.

### BRIEF DESCRIPTION OF THE DRAWINGS

Possible embodiments are described in more detail in the following detailed description with reference to the following figures. Others features, details and advantages of the embodiments will become more apparent from the detailed illustrating description given hereafter with respect to the drawings on which:

FIG. 1 shows an isometric of a connector according to some embodiments.

FIG. 2 shows a longitudinal cross section view of the aluminum junction part and the copper terminal before joining according to some embodiments.

FIG. 3 shows a longitudinal cross section view of the aluminum junction part and the copper terminal after joining according to some embodiments.

FIG. 4A shows a longitudinal cross section view of the aluminum junction part and the copper terminal after joining according to some embodiments.

FIG. 4B shows a zoomed detail of a longitudinal cross section view of a double coating between the aluminum junction part and the copper terminal according to some embodiments.

FIG. 5 shows a longitudinal cross section view of the aluminum junction part and the copper terminal with an integral center pin according to some embodiments.

FIG. 6 shows a longitudinal cross section view of the aluminum junction part and the copper terminal with a crossing centre pin before assembling according to some embodiments.

FIG. 7 shows a longitudinal cross section view of the aluminum junction part and the copper terminal, with a crossing centre pin after assembling according to some embodiments.

FIG. 8 shows a longitudinal cross section view of the joining of the aluminum cable and the aluminum junction part according to some embodiments.

### DETAILED DESCRIPTION

One object of the disclosure is a connector 1. The connector 1 comprises an aluminum cable 2 and a copper terminal 4. Since the two materials are not easy to bond one another, according to a feature, the connector 1 further comprises a junction part 3, to be inserted in between the aluminum cable 2 and the copper terminal 4, so as to join them while assuring the electrical continuity.

Accordingly, the junction part 3 is made of aluminum and comprises a first end 5 able to be joined to the aluminum cable 2 and a second end 6 able to be joined to the copper terminal 4.

By adding the junction part 3, the connector 1 allows to separate the joining of the aluminum cable 2 with the copper terminal 4 in two joining: a first joint between the first end 5 of the junction part 3 and the aluminum cable 2 and a second joint between the second end 6 of the junction part 3 and the copper terminal 4. This allows applying different methods of joining to the two ends 5, 6 and to distinguish two joining times.

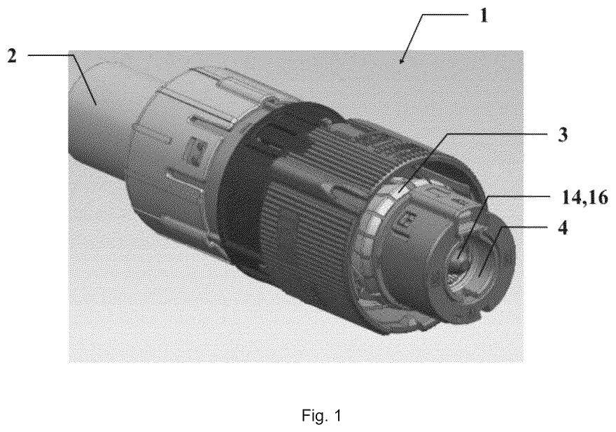

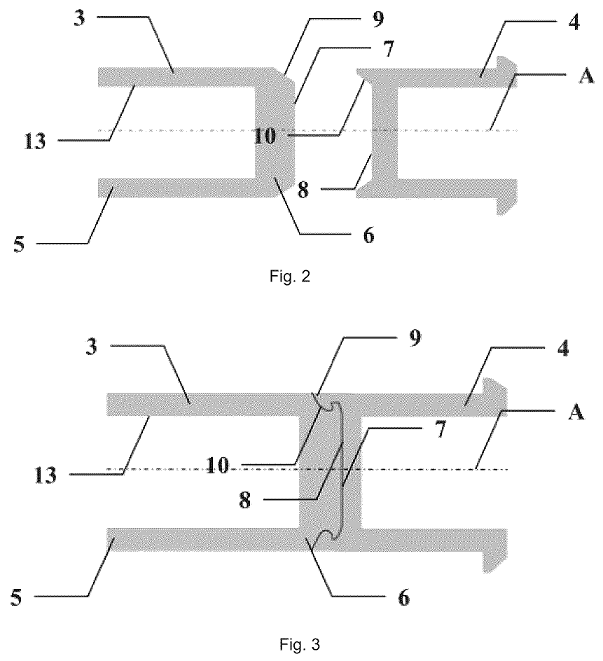

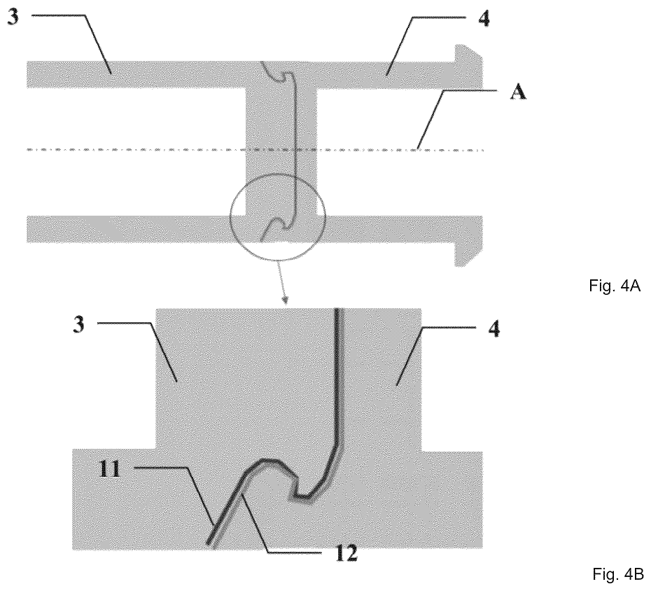

Let us first focus on the second end 6 of the junction part 3. With respect to FIGS. 1 and 2, according to a feature, the second end 6 comprises a first face 7 perpendicular to a connector's axis A and the copper terminal 4 comprises a corresponding second face 8 perpendicular to the connector's axis A, facing the first face 7. Corresponding here means that both faces 7, 8 are complementary, and able to be disposed in contact one against the other, while maintaining an alignment with the connector's axis A. The shape of the first face 7 may be any, but the shape of the second face 8 must be symmetrical so as to ensure a perfect match. As an example, illustrated in FIGS. 1 and 2, both faces 7, 8 can be planar.

According to a feature, one of the faces 7, 8 among the first face 7 of the second end 6 and the second face 8 of the copper terminal 4 comprises an outer chamfer 9 and the other face 7, 8 comprises a corresponding inner chamfer 10. In FIGS. 1 and 2, the first face 7 comprises the outer chamfer 9 and the second face 8 comprises the inner chamfer 10. The outer chamfer 9 is the one whose normal is pointing out from the axis A. Reciprocally, the inner chamfer 10 is the one whose normal is pointing in toward the axis A. The opposite, where the first face 7 would comprise the inner chamfer 10 and the second face 8 would comprise the outer chamfer 9 is also possible and is equivalent.

The outer chamfer 9 is shaped in the form of an outer cone. The cone is centered upon the connector's axis A. It joins the face 7, 8 to the outer diameter of the part, either the aluminum junction part 3 or the copper terminal 4. The face 7, 8 is disposed at the smallest diameter of the cone. The face 7, 8 is thus outside of the cone, at the very distal end of the part.

The inner chamfer 10 is shaped in the form of an inner cone. The cone is centered upon the connector's axis A. It joins the face 7, 8 to the outer diameter of the part, either the aluminum junction part 3 or the copper terminal 4. The face 7, 8 is disposed at the smallest diameter of the cone. The face 7, 8 is thus inside the cone. The inner chamfer 10 is thus more distal than the face 7, 8.

Both chamfers 9, 10 are complementarily shaped so as to have the inner chamfer 10 welcoming the outer chamfer 9 inside the inner chamfer 10. So doing, when the first face 7 is in contact with the second face 8, the inner chamfer 10 covers, at least partially, the outer chamfer 9.

Accordingly, when both chamfers 9, 10 are placed together, the outer chamfer 9 becomes the inside chamfer 9, and the inner chamfer 10 becomes the outside chamfer 10, surrounding the inside chamfer 9.

So disposed, one against another, both chamfers 9, 10 can be joined by cold forging. FIG. 1 shows the two parts 3, 4 before cold forging joining. FIG. 2 shows the same two parts 3, 4 after cold forging joining.

To obtain a secure joining, the cold forging is applied radially on both chamfers 9, 10, that is at a point when the two chamfers 9, 10 are superposed. The cold forging is done by applying a concentric deformation of both chamfers 9, 10 typically with a concentric coronal tool able to apply a radial effort. The cold forging applies a radial deformation so as to radially interpenetrate the outside chamfer 10 into the inside chamfer 9. The deformation inhibits any axial and radial relative movement of the chamfers 9, 10. The chamfers 9, 10 are then intimately joined, ensuring both mechanical bond and electrical conduction.

According to another feature both chamfers 9, 10 are angled with respect to connector's axis A. Since both chamfers 9, 10 are complementary, their respective angles are equal, one being inner while the other being outer. The angles, with respect to the connector's axis A, are comprised between 30° and 60°. As illustrated in FIGS. 1 and 2, the angles are preferentially 45°.

In order to allow a good cold forging, the thickness of the first face 7 is comprised between 1 mm and 4 mm, preferably equal to 2 mm. Similarly, the thickness of the second face 8 is comprised between 1 mm and 4 mm, preferably equal to 2 mm. In order to keep a good balance, the ratio of the thickness of the first face 7 to the thickness of the second face 8 is comprised between 25% and 75%, preferentially equal to 50%, where both thicknesses are equal.

The thickness of a face 7, 8 determines, through the angle, the longitudinal length, along the connector's axis A, of the associated chamfer 9, 10. With a 45° angle, the longitudinal length of the chamfer 9, 10 is equal to the thickness of its supporting face 7, 8.

The contact of aluminum with copper could produce metallic oxides, mainly Al₂O₃. According to another feature, in order to protect from oxidation, the aluminum junction part 3 and the copper terminal 4 are totally separated. To do so, the first face 7 of the second end 6 and the second face 8 of the copper terminal 4 are wholly separated by two layers of coating 11, 12. “Wholly separated” or “totally separated” here means that any of both coating 11, 12 are continuous and fully covers their support so as to preclude any contact between the aluminum junction part 3 and the copper terminal 4.

The separation may advantageously comprise at least a first coating 11, preferably of silver. The first coating 11 is disposed between the first face 7 and the second face 8. The separation may advantageously comprise at least a second coating 12, preferably of nickel. The second coating 12 is disposed between the first face 7 and the second face 8.

The separation may preferentially comprise, both the first coating 11 of silver and the second coating 12 of nickel. In that case, the first coating 11 is disposed between the first face 7 and the second face 8, and the second coating 12 is disposed between the first coating 11 and the second face 8. While protecting against oxidation, the coatings 11, 12 ensure a good electrical conduction.

When it comes to manufacturing, a preferred process comprises the following steps. First, the second coating 12 of nickel is deposed over the copper terminal 4, at least over all the surface intended to come in contact with the aluminum junction part 3. Then, the first coating 11 of silver is deposed over the second coating 12 of nickel.

It can be noted that, the coating 11, 12 are not damaged by the cold forging operation.

Let us now focus on the first end 5 of the junction part 3. This is illustrated in FIG. 8. Since the aluminum cable 2, be it massive or stranded, noticeably exhibits the shape of an outer cylinder, the first end 5 is advantageously shaped to comprise an inner cylinder 13, along the axis A of the connector 1. The inner cylinder 13 is preferentially set up to tightly accommodate the outer diameter of the aluminum cable 2. Thus, the aluminum cable 2 can be inserted in the inner cylinder 13. Once inserted, according to another feature, the aluminum cable 2 and the inner cylinder 13 of the first end 5 of the junction part 3 can be joined by Electro Magnetic Pulse Technology welding or EMPT welding. The EMPT causes the inner cylinder 13 to shrink around the outer diameter of the platinum cable 2.

EMPT welding is a technology that realizes a cold welding based on electromagnetic energies. This technology can be applied only to conductive materials. It has the advantage of being appliable to materials exhibiting different fusing points, contrary to other welding technology. This technology can thus be applied to the joining of a copper part with an aluminum part. It can also be applied to the joining of an aluminum part with an aluminum part.

The connector 1 is mainly intended to high currents. As used herein, high current means 500 A or more. The aluminum cable 2 preferably exhibits a section comprised between 95 and 160 mm². Accordingly, the inner cylinder 13 has its diameter comprised between 15 and 23 mm.

In order to be deformed during the aluminum cable 2 to aluminum junction part 3 joining operation by EMPT welding and to ensure a better electrical performance, the wall thickness of the inner cylinder 13 is advantageously comprised between 1 and 2.5 mm, and is preferably equal to 2,0 mm.

According to another feature, the connector 1 further comprises a center pin 14. The center pin 14 is aligned with the connector's axis A.

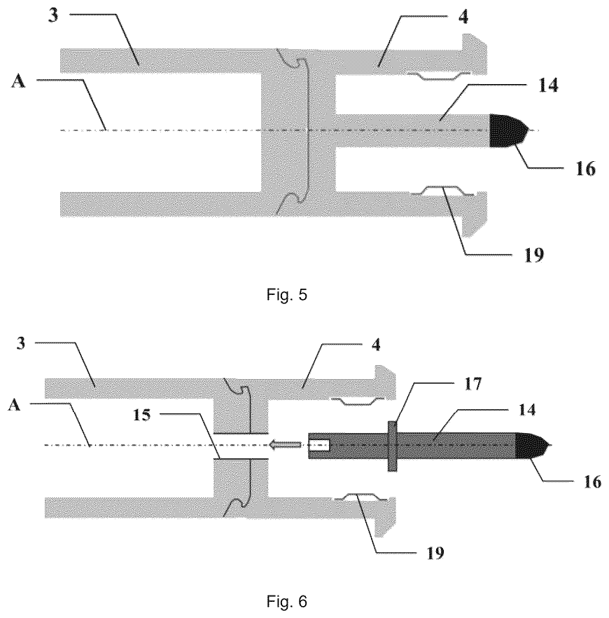

According to a first embodiment, more particularly illustrated in FIG. 5, the center pin 14 is integral to the copper terminal 4.

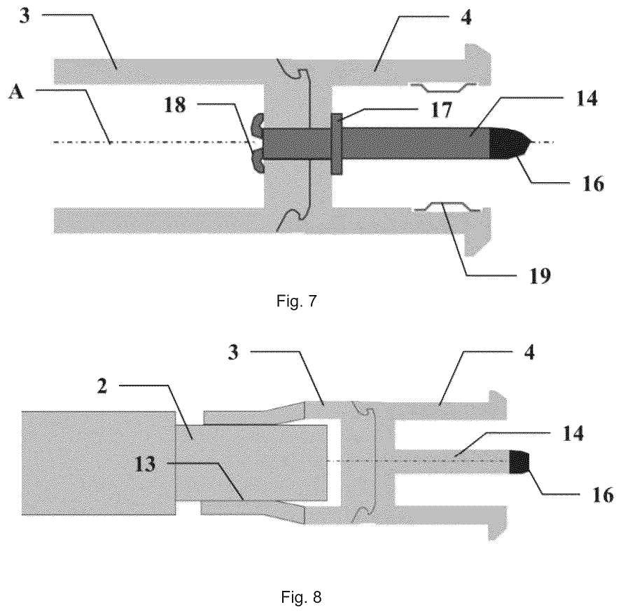

According to another embodiment, illustrated in FIGS. 6 and 7, the center pin 14 is inserted and secured into an axial hole 15 drilled through both faces 7, 8. The axial hole 15, along the connector's axis A, is set up to tightly receive the center pin 14. As illustrated in FIG. 7, the center pin 14 once engaged in the axial hole 15, is secured by longitudinal crimping.

According to another feature, the center pin 14 comprises a stop 17 able to cope with the axial hole 15 on one end of the axial hole 15. On the other side of the axial hole 15, the end of the inserted center pin 14 is crimped so as to broaden into a crimp 18, forming another stop, so as to longitudinally secure the center pin 14 in the axial hole 15.

According to another feature, more particularly illustrated in FIGS. 5 to 7, the center pin 14 comprises a distal end 16 made of an insulating material. The center pin 14 is conductive and connected, through the junction part 3, to the aluminum cable 2. It can thus be at a high electrical potential. So, to avoid a possibly vulnerating contact between the high potential and an operator's body part, such as a finger, when the connector 1 is disconnected/open, the tip or distal end 16 of the center pin 16 is insulated.

In all the preceding embodiments, the copper terminal 4 can comprise at least one flexible lamella 19 to help contact with a corresponding terminal of a counter connector and to help transferring electricity.

When it comes to manufacturing such a connector 1, the disclosure further consists of a manufacturing method. The method comprises the following steps. A first step consists in inserting the outer chamfer 9 into the inner chamfer 10. A further step consists in joining the second end 6 of the junction part 3 with the copper terminal 4 by cold forging, so as to interpenetrate both chamfers 9, 10. A further step consists in joining the first end 5 with the aluminum cable 2 by EMPT welding. In order not to too heavily deforms the junction part 3, which could occur when joining the first end 5 with the aluminum cable 2, the two steps must be applied in this order.

Alternately, the two steps can be applied simultaneously.

While there is shown and described the present preferred embodiment of the invention, it is to be distinctly understood that this invention is not limited thereto but may be variously embodied to practice within the scope of the following claims.

While the invention has been described with reference to an exemplary embodiment(s), it will be understood by those skilled in the art that various changes may be made, and equivalents may be substituted for elements thereof without departing from the scope of the invention. In addition, many modifications may be made to configure a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

### REFERENCE NUMBER LIST

1 connector
2 aluminum cable
3 junction part
4 copper terminal
5 first end
6 second end
7 first face
8 second face
9: outer/inside chamfer
10 inner/outside chamfer
11 first coating (Ag)
12 second coating (Ni)
13: inner cylinder
14 center pin
15 axial hole
16 distal end
17 stop
18 crimp
19 lamella
A connector's axis

1. A connector, comprising:
an aluminum cable;
a copper terminal; and
a junction part made of aluminum, wherein the junction part comprises a first end able to be joined to the aluminum cable and a second end able to be joined to the copper terminal.

2. The connector according to claim 1, wherein the second end comprises a first face perpendicular to a connector's axis, and the copper terminal comprises a corresponding second face perpendicular to the connector's axis, facing the first face, and one of the faces among the first face of the second end and the second face of the copper terminal comprises an outer chamfer and the first face comprises a corresponding inner chamfer, shaped to cover and receive the outer chamfer, and both chamfers are joined by cold forging.

3. The connector according to claim 2, wherein the first face of the second end and the second face of the copper terminal are wholly separated by a first coating of silver, disposed between the first face and the second face, and a second coating of nickel, disposed between the first coating and the second face.

4. The connector according to claim 2, wherein the cold forging is applied radially on both chamfers so as to radially interpenetrate the outer chamfer into the inner chamfer, so as to inhibit any axial and radial relative movement of the chamfers.

5. The connector according to claim 1, wherein both chamfers are angled, with respect to the connector's axis, at an angle between 30° and 60.

6. The connector according to claim 5, wherein both chamfers are angled, with respect to the connector's axis at a 45° angle.

7. The connector according to claim 1, wherein the first end comprises an inner cylinder, along the connector's axis, set up to tightly receive the aluminum cable, and the aluminum cable, inserted in the inner cylinder, and the inner cylinder of the first end, are joined by electromagnetic pulse technology welding.

8. The connector according to claim 1, further comprising a center pin, the center pin being integral to the copper terminal.

9. The connector according to claim 8, further comprising a center pin, both faces comprising an axial hole, along the connector's axis, set up to tightly receive the center pin, and the center pin and the axial hole, once engaged one another, are joined by longitudinal crimping.

10. The connector according to claim 8, wherein a distal end of the center pin is made of an insulating material.

11. A method of manufacturing a connector having an aluminum cable, a copper terminal, and a junction part made of aluminum, wherein the junction part comprises a first end able to be joined to the aluminum cable and a second end able to be joined to the copper terminal, wherein the second end comprises a first face perpendicular to a connector's axis, and the copper terminal comprises a corresponding second face perpendicular to the connector's axis, facing the first face, and one of the faces among the first face of the second end and the second face of the copper terminal comprises an outer chamfer and the first face comprises a corresponding inner chamfer, shaped to cover and receive the outer chamfer, the method comprising:
inserting the outer chamfer into the inner chamfer;
joining the second end of the junction part with the copper terminal by cold forging, so as to interpenetrate both chamfers; and
joining the first end with the aluminum cable by electromagnetic pulse technology welding.

12. The method according to claim 11, wherein the last two steps are performed in the order listed.

13. The method according to claim 11, wherein the last two steps are performed simultaneously.
